(19) United States
(12) Patent Application Publication
(10) Pub. No.: US 2017/0295419 A1
(43) Pub. Date: Oct. 12, 2017

(54) MICROPHONE SYSTEM WITH MONITOR SOUND

(71) Applicant: DPA Microphones A/S, Allerød (DK)

(72) Inventors: Christian Poulsen, København K (DK); Anders Poulsen, Holte (DK)

(73) Assignee: DPA Microphones A/S, Allerød (DK)

(21) Appl. No.: 15/511,179

(22) PCT Filed: Sep. 15, 2015
(86) PCT No.: PCT/EP2015/071076

§ 371 Date: Mar. 14, 2017

(30) Foreign Application Priority Data
Sep. 15, 2014 (EP) 14184837.4

(51) Int. Cl. H04R 1/08; H04R 5/04; H04R 29/00; H04R 1/22

(52) U.S. Cl. CPC H04R 1/083; H04R 1/222; H04R 5/04; H04R 29/007; H04R 5/033

(57) ABSTRACT

A microphone system includes a microphone with a microphone output for converting a first acoustic audio signal to a microphone signal, the system including: a head part including a loudspeaker with a loudspeaker input for converting a loudspeaker signal to a second acoustic audio signal; a first connector for connecting the system to an auxiliary device and including a housing and a first terminal; a unit for preprocessing the microphone signal having at least a first input connected to the microphone output, a first output connected to the loudspeaker input, and a second output connected to the first terminal. The unit is configured to: receive the microphone signal on the first input to form a input signal; and process the input signal to form first and second output signals on the first and second outputs, respectively, the first output signal and the second output signal based on the input signal.

The present invention relates to a high end body worn microphone system with a miniature microphone and an earpiece providing audio feedback to the user.

### BACKGROUND

Actors, musicians, TV hosts, performers or alike, want their voice to be recorded or amplified in high sound quality. Further, to be able to adjust the pitch or similar of one's voice, it is beneficial to be able to hear one's own voice. Hearing one's own performance is conventionally also known as “monitor sound”.

However, in many situations, e.g. concerts, venues etc., it is difficult, if not impossible, for the performer to hear his/her own voice. This may be due to such as a noisy crowd, loud instruments etc.

Further, for the performer to benefit from hearing his/her own voice, it is important that the performer's voice is not significantly delayed before reaching the ear.

Further, actors, TV hosts, performers etc. wishes to be able to achieve audible cues and information while performing their act, e.g. a producer needs to pass on information of when to speak and when not to, what to say, where to look, information of changes etc.

### SUMMARY

There is a need for an apparatus and method for provision of high quality monitor sound.

Further, it is an object of the present invention to provide a device which will provide monitor sound which is not delayed, or at least significantly limited delayed.

It is a further object of the present invention to provide a device which will allow concurrent reception of monitor sound and external audible information, such as audible cues.

Accordingly, a microphone system comprising a microphone with a microphone output for converting a first acoustic audio signal to a microphone signal, is provided. The microphone system comprises: a head part, a first connector, and a preprocessing unit. The head part comprises a first loudspeaker with a first loudspeaker input for converting a first loudspeaker signal to a second acoustic audio signal. The first connector is adapted for connecting the microphone system to an auxiliary device, and the first connector comprises a connector housing and a first terminal. The preprocessing unit is adapted for preprocessing the microphone signal, and the preprocessing unit has at least a first input connected to the microphone output, a first output connected to the first loudspeaker input, and a second output connected to the first terminal of the first connector. The preprocessing unit is configured to: receive the microphone signal on the first input to form a first input signal; and process the first input signal to form a first and second output signal on the first and second output, respectively, wherein the first output signal and second output signal are based on the first input signal.

Also disclosed is a method for providing monitor sound in a microphone system comprising a microphone and a first loudspeaker. The method comprises: receiving a microphone signal from the microphone to form a first input signal; forming a first output signal and a second output signal, wherein the first output signal and the second output signal are based on the first input signal; applying the first output signal to a first output, wherein the first output is configured to be connected to the first loudspeaker; and applying the second output signal to a second output.

Further disclosed is a preprocessing unit for preprocessing a microphone signal from a microphone system with a microphone and a first loudspeaker. The preprocessing unit has at least a first input for receiving a microphone signal, a first output for connecting to a first loudspeaker input, and a second output. The preprocessing unit is configured to: receive a microphone signal to form a first input signal; form a first output signal and a second output signal, wherein the first output signal and the second output signal are based on the first input signal; apply the first output signal to the first output; and apply the second output signal to the second output.

It is an advantage of the present invention that a user, such as a music performer, is provided with high quality monitor sound. Further, the disclosed microphone system provides monitor sound with reduced or substantially no delay thus delivering useful feedback of own performance to the user in a noisy environment.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates an exemplary microphone system,

FIG. 2 schematically illustrates an exemplary microphone system providing monitor sound,

FIG. 3 schematically illustrates an exemplary microphone system providing monitor sound, wherein a head part comprising a first and second part,

FIG. 4 schematically illustrates an exemplary microphone system providing monitor sound, wherein a head part comprises a first and second loudspeaker,

FIG. 5 schematically illustrates an exemplary microphone system providing monitor sound, wherein a head part comprises a first and second loudspeaker,

FIG. 6 schematically illustrates an exemplary microphone system providing monitor sound, wherein a preprocessing unit comprises a third output,

FIG. 7 schematically illustrates an exemplary microphone system providing monitor sound, wherein a head part comprises a preprocessing unit,

FIG. 8 schematically illustrates an exemplary microphone system providing monitor sound, wherein a connector housing comprises a preprocessing unit,

FIG. 9 schematically illustrates an exemplary preprocessing unit for providing monitor sound,

FIG. 10 schematically illustrates an exemplary preprocessing unit for providing monitor sound, wherein the preprocessing unit comprises a second splitter circuit,

FIG. 11 schematically illustrates an exemplary preprocessing unit for providing monitor sound, wherein the preprocessing unit comprises a second amplifier circuit,

FIG. 12 schematically illustrates an exemplary preprocessing unit for providing monitor sound, wherein the preprocessing unit comprises a second input and a combiner,

FIG. 13 schematically illustrates an exemplary preprocessing unit for providing monitor sound, wherein the preprocessing unit comprises a second input and a combiner,

FIG. 14 schematically illustrates a flow diagram of an exemplary method.

### DETAILED DESCRIPTION

The figures are schematic and simplified for clarity, and they merely show details which are essential to the understanding of the invention, while other details have been left out. Throughout, the same reference numerals are used for identical or corresponding parts.

The head part may comprise the microphone. For example, the microphone may be a head mounted microphone. The head part may comprise a microphone boom with the microphone mounted at a distal end thereof. The microphone boom may be releasably attached or mounted to an ear hook. Additionally the head part comprising the microphone may comprise a first part with the microphone, and a second part with the first loudspeaker. The first part and the second part may be connected by a neck connector. Alternatively the microphone may be a separate part, such as a vocal microphone or a lavalier microphone. The chosen embodiment may rely on the specific use or setting. For example, a lavalier microphone may be beneficial in a setting, where the microphone should be disguised. Conversely a vocal microphone or a head mounted microphone may be beneficial when audio quality or noise reduction is essential.

The microphone system may comprise one or more output members, such as a first output member and/or a second output member. An output member, such as the first output member and/or the second output member may be configured for directing an acoustic audio signal, such as the second acoustic audio signal, into or within an ear of a user, such as a first ear and/or a second ear of a user.

An output member, such as the first and/or second output member, or at least a part of the output member may be configured for positioning in the ear canal of the user. The output member may be shaped such that it does not block the ear canal, such that the user is not prevented from perceiving surrounding sounds, e.g. voices or music. Alternatively the output member may be shaped to block the ear canal, such that the user is not subjected to surrounding sounds and/or noise.

The microphone system may comprise a second loudspeaker with a second loudspeaker input for converting a second loudspeaker signal to a third acoustic audio signal. Hence, audio signals may be provided to both ears of a user of the microphone system. Further, a stereo signal may be provided to the user, or different audio signals may be provided to each of the user's ear. An output member, such as the second output member, may be configured for directing the acoustic signal from the second loudspeaker, i.e. the third acoustic audio signal, into a second ear of a user.

The first loudspeaker and the second loudspeaker may be provided with the same input, such as to provide similar audible information to both ears of the user. Hence, the first output of the preprocessing unit may be connected to the first loudspeaker input and the second loudspeaker input. Alternatively or additionally, the preprocessing unit may comprise a third output for connecting to the second loudspeaker. The third output may be connected to the second loudspeaker input. The third output may output a third output signal. In the preprocessing unit, a third output signal may be formed, and the third output signal may be applied to a third output. The third output may be configured to be connected to the second loudspeaker. The third output signal may be based on the first input signal.

By providing the preprocessing unit with a third output, the microphone system is able to provide different signals to the first and second loudspeakers. The first and the third output signals may differ in content or contain the same content. The first and the third output signal may differ to create an acoustic stereo signal. Alternatively, the first the third output signal may differ to contain one type of information in one output signal and another type of information in the other output signal. For example, the first output signal may be based on the first input signal, and the third output may be based on an external input, e.g. a second input signal.

An external input signal may be received to form a second input signal. The preprocessing unit may comprise a second input for receiving a second input signal. The first and/or third output signal may be based on the second input signal. The second input may provide connection of an external input such as for receiving external audible information e.g. producer or prompter cues or music.

The preprocessing unit may comprise one or more processing parameters. Processing parameters may for example comprise cutoff frequency in relation to an applied filtering and/or gain, i.e. volume. The one or more processing parameters in the preprocessing unit may be adjustable. The microphone system/preprocessing unit may comprise a user interface for controlling one or more processing parameters, such as first gains or weighting coefficients (a1, a2) applied to the first input signal and/or second gains pt weighting coefficients (b1,b2) applied to the second input signal.

The preprocessing unit may comprise a splitter circuit for splitting a split input signal such as the first input signal. The split input signal may be split to two identical split output signals, i.e. splitting may be understood in the sense of copying the split input signal to two or more split output signals, e.g. the first and second output signals. Alternatively, the split input signal may be split to two or more split output signals, wherein one split output signal comprises a signal identical to the split input signal, and another split output signal comprises a part of the input signal. For example, a first split output signal may comprise a part of a first split input signal, and a second split output signal may be identical to the first split input signal.

The preprocessing unit may comprise an amplifier, such as a first amplifier and/or a second amplifier. The first amplifier may be located between the first input and the first output. An amplifier, such as the first amplifier may be located between the splitter circuit and the first output. An amplifier, such as the first amplifier, may amplify the first output signal for providing an amplified first output signal, such as the first loudspeaker signal, to the first loudspeaker. The first amplifier may receive an input signal, such as the microphone signal, the first input signal and/or the first split output signal. The second amplifier may receive an input signal, such as the second input signal providing connection of an external input. Alternatively, the first amplifier may receive both a first amplifier input signal, such as the microphone signal, the first input signal and/or the first split output signal, and a second amplifier input signal, such as the second input signal.

The preprocessing unit may comprise analog to digital conversion. An output signal of the preprocessing unit, such as the first, the second and/or the third output signal may be digital, such as a digital first, a digital second and/or a digital third output signal, respectively. The preprocessing unit may comprise one or more analog to digital converters, such as a first analog to digital converter and/or a second analog to digital converter.

The first analog to digital converter may be located between the first input and the second output. Hence, processing of the signal on the first input, such as the first input signal and/or the microphone signal, may comprise analog to digital conversion of at least a part of the first input signal to form the second output signal.

The second analog to digital converter may be located between the first input and the first output. Hence, processing of the signal on the first input, such as the first input signal and/or the microphone signal, may comprise analog to digital conversion of at least a part of the first input signal to form the first output signal.

The function of the second analog to digital converter may be incorporated in the first analog to digital converter, such that processing of the signal on the first input, such as the first input signal and/or the microphone signal, may comprise analog to digital conversion of at least a part of the first input signal to form the first and the second output signal.

The preprocessing unit may comprise analog and/or digital signal processing. In relation to the description above, splitting and/or amplification may be accomplished by analog signal processing and/or digital signal processing. Additionally or alternatively, the preprocessing unit may comprise one or more filters, such as a first filter and/or a second filter. The first filter and/or second filter may comprise different filters such as low-pass, high-pass, notch, bandwidth etc. and/or a combination of different filters.

The preprocessing unit may comprise a digital to analog converter for converting a digital signal to an analog signal. Thereby, the preprocessing unit may convert digitally processed signals to an analog output signal, such as the first, second and/or third output signals being a first analog, second analog and/or third analog output signal, respectively.

The preprocessing unit may be powered by an internal battery. Alternatively, or in combination, the preprocessing unit may be powered via a connection to an auxiliary device.

The preprocessing unit may be comprised in a connector housing, such as the first connector housing. Alternatively, the preprocessing unit may be comprised in the head part.

The microphone system comprises a first connector comprising a connector housing and a first terminal. As described earlier, the processing unit may comprise a second input, such as for providing connection of an external input. The first connector may comprise a second terminal. The second terminal may be connected to the second input of the preprocessing unit. Thereby, the first connector may connect both the first output and the second input to an auxiliary device via a single connector, i.e. the first connector. A single connector comprising both the first and second terminals provide for a more user friendly device, where only one connector needs to be connected.

Alternatively, the microphone system may comprise a second connector. The second connector may comprise a second connector housing and the second terminal connected to the second input of the preprocessing unit. A microphone system comprising a first and a second connector allows for applying different auxiliary devices to each connector, and provides for backward compatibility. The first connector may connect the second output to a first auxiliary device, while the second connector connects the second input to a second auxiliary device.

A preprocessing unit according to the above description may be incorporated in a housing of a connector. Hence, a connector device for a microphone system with a microphone and a first loudspeaker is obtained. The connector device may comprise a housing accommodating the preprocessing unit. The connector device may be inserted between conventional equipment, such as auxiliary device(s), microphone and earpiece(s), to provide the user with audible feedback from the microphone.

The microphone system may incorporate any and/or all of the features described in relation to the preprocessing unit. Equally, features described in relation to the preprocessing unit of the microphone system may be incorporated in the preprocessing unit without the microphone system.

Further, the preprocessing unit and/or the preprocessing unit of the microphone system may incorporate any and/or all of the features described in relation to the method for providing monitor sound. Equally, features described in relation to the preprocessing unit and/or the microphone system may be incorporated in the method for providing monitor sound.

The preprocessing unit provides the first output signal and the second output signal based on the first input signal. The first output signal and the second output signal may be based on the second input signal. The preprocessing unit may provide a third output signal based on the first input signal and/or the second input signal if present. In an exemplary headset/preprocessing unit, the first output signal y1 and the third output signal y3 are given by

y1=f1(x1,x2)=a1x1+a2x2

y3=f3(x1,x2)=b1x1+b2x2,

where a1, a2, b1, and b2 are weighting coefficients, and x1 is the first input signal from the microphone and x2 is the optional second input signal from the external unit. The weighting coefficients may be frequency dependent and vary with frequency.

In an exemplary headset/preprocessing unit, a1≠b1 and/or a2≠b2. In an exemplary headset/preprocessing unit, a1 or b1 is zero. In an exemplary headset/preprocessing unit, a2 and/or b2 is zero.

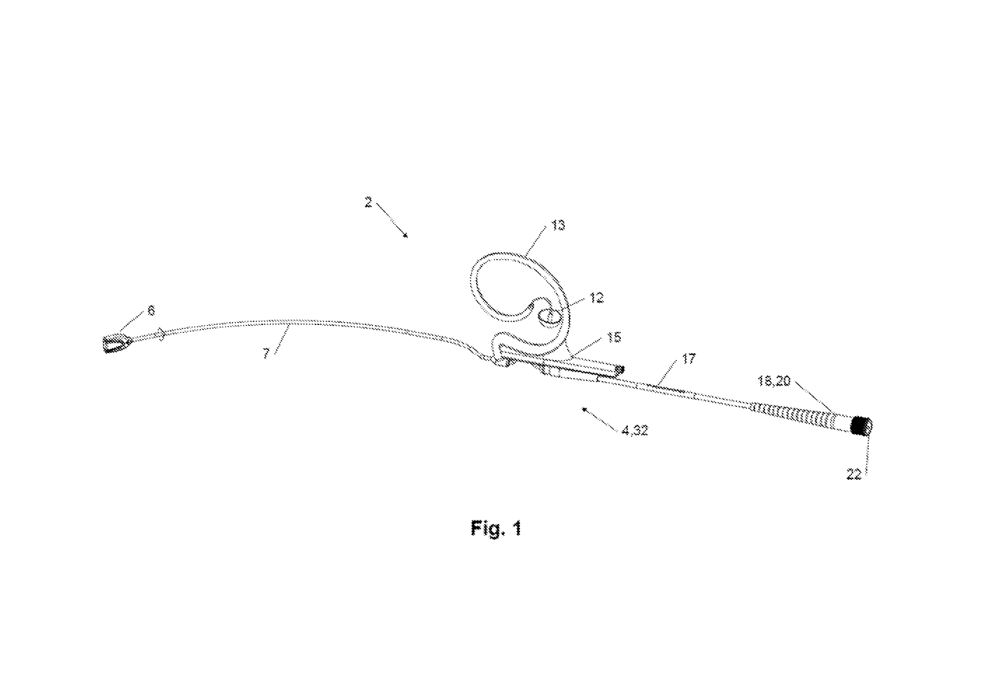

FIG. 1 schematically illustrates an exemplary microphone system 2. The exemplary microphone system 2 comprises a head part 4. The head part 4 comprises a microphone 6 attached to a microphone boom 7, and a first loudspeaker 12 attached to a first ear hook 13. The first ear hook 13 is configured for affixing the head part 4 to an ear of a user. The first ear hook 13 comprises a base part 15. The microphone boom 7 is attached to the base part 15. The microphone system 2 further comprises a conductor 17 connected at one end to the base part 15 and at another end connected to a connector 18. The connector 18 comprises a housing 20 and a first terminal 22. The head part 4 as illustrated in FIG. 1 comprises a first part 32. The head part 4 may in an alternative exemplary microphone system (not shown) comprise a second part, wherein the second part may comprise a second ear hook. The first loudspeaker may alternatively be attached to the second ear hook.

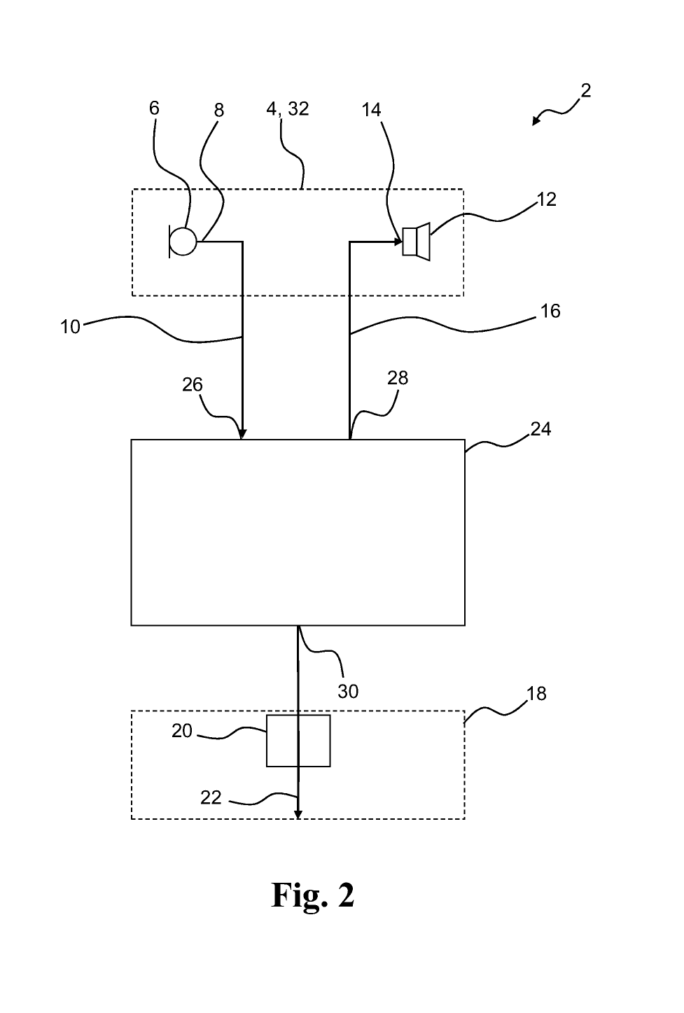

FIG. 2 schematically illustrates an exemplary microphone system 2 for providing monitor sound to a user wearing the microphone system 2. The exemplary microphone system 2 comprises a head part 4, and the head part 4 comprises a microphone 6 with a microphone output 8 and a first loudspeaker 12 with a loudspeaker input 14. The microphone 6 is adapted to receive and convert a first acoustic audio signal (not shown) to a microphone signal 10, and the first loudspeaker 12 is adapted to receive and convert a first loudspeaker signal 16 to a second acoustic audio signal (not shown).

The microphone 6 may be positioned to register the voice of the user wearing the microphone system 2. The first loudspeaker 12 provides monitor sound to the user. The monitor sound i.e. the second acoustic signal, may be provided directly to the ear of the user by the first loudspeaker 12 being placed in the ear canal of the user. In an alternative embodiment the first loudspeaker 12 may be placed near to the ear of the user and a tube, i.e. an acoustic tube (not shown), may direct the second acoustic audio signal from the first loudspeaker 12 to the ear canal of the user.

The exemplary microphone system 2 of FIG. 2 further comprises a connector 18, for connecting the microphone system 2 to an auxiliary device (not shown). The connector 18 comprises a connector housing 20 and a first terminal 22. The first terminal 22 is connectable to the auxiliary device.

The exemplary microphone system 2 of FIG. 2 further comprises a preprocessing unit 24 for preprocessing of the microphone signal 10 to form a first and second output signal. The preprocessing unit 24 comprises a first input 26, a first output 28 and a second output 30. The first input 26 is connected to the microphone output 8 and receives the microphone signal 10 as a first input signal. The first output 28 is connected to the first loudspeaker input 14 and the first loudspeaker 12 receives the first loudspeaker signal 16 as a first output signal from the first output 28. The second output 30 is connected to the first terminal 22 of the connector 18 in the connector housing 20. The second output 30 is able to be connected to an auxiliary device via the first terminal 22.

The preprocessing unit 24 may comprise an internal power source, such as a battery, or the connector 18 may provide power to the preprocessing unit 24 via an external power source, such as an auxiliary device.

The exemplary microphone system 2 of FIG. 2 further illustrates the head part 4 comprising a first part 32, wherein the first part 32 comprises the microphone 6 and the first loudspeaker 12.

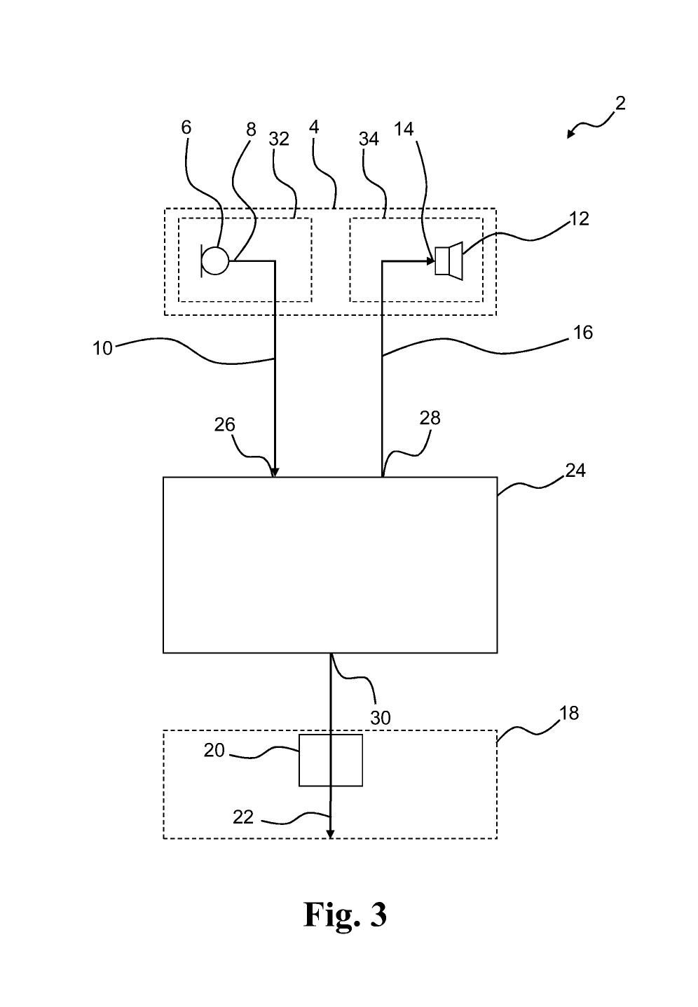

FIG. 3 schematically illustrates an exemplary microphone system 2 wherein the head part 4 comprises a first part 32 and a second part 34. The first part 32 comprises the microphone 6, and the second part 34 comprises the first loudspeaker 12. This illustrated exemplary microphone system 2, may e.g. be a microphone system where the first loudspeaker 12 and the microphone 6 are positioned on either side of the head, or it may be two separatable devices.

The configuration as illustrated in FIG. 3, where the microphone 6 is provided in the first part 32 and the first loudspeaker 12 is provided in the second part 34, provides reduced feedback noise, i.e. echo. The monitor sound provided by the first loudspeaker 12 is dependent on the acoustic input of the microphone 6. Thus, separating the first loudspeaker 12 from the microphone 6 provides less risk of the microphone 6 registering the acoustic output of the first loudspeaker 12.

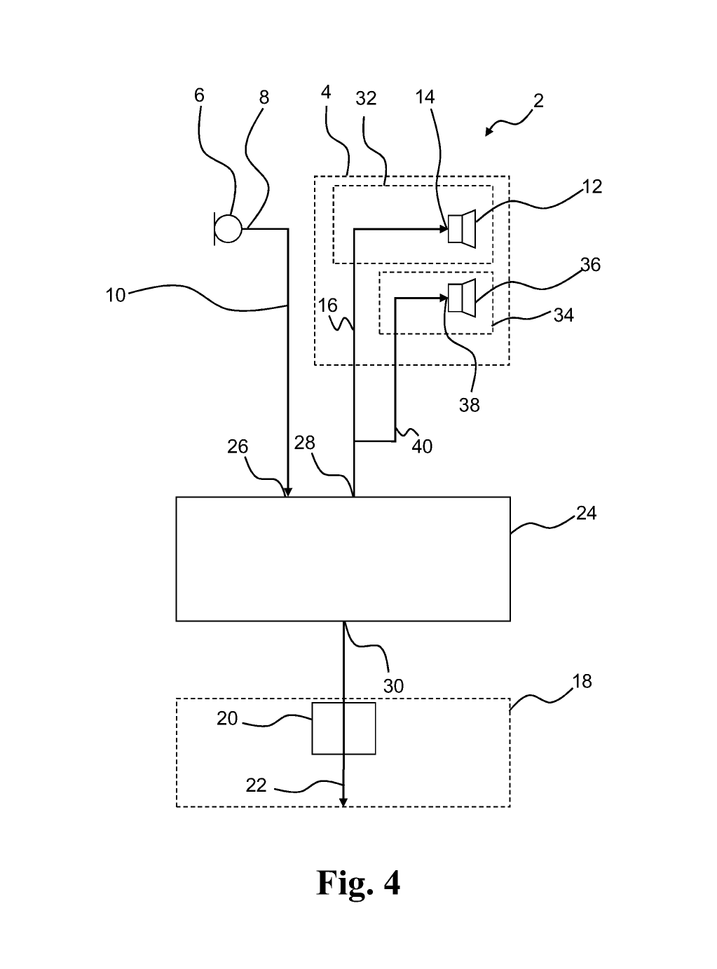

FIG. 4 schematically illustrates an exemplary microphone system 2 wherein the head part 4 comprises a first part 32 and second part 34. The first part 32 comprises the first loudspeaker 12. The second part 34 comprises a second loudspeaker 36 with a second loudspeaker input 38. The second loudspeaker 36 is adapted to receive and convert a second loudspeaker signal 40 to a third acoustic audio signal (not shown).

FIG. 4 further illustrates a general concept where the microphone 6 is not comprised in the head part 4. The microphone may e.g. be a lavalier microphone or a vocal microphone, and in these and similar cases the microphone 6 may be an individual part not comprised in the head part 4.

In the, in FIG. 4 illustrated, exemplary microphone system 2, the second loudspeaker signal 40 is the same as the first loudspeaker signal 16, and thus the first loudspeaker 12 and the second loudspeaker 36 reproduce the same acoustic audio signal.

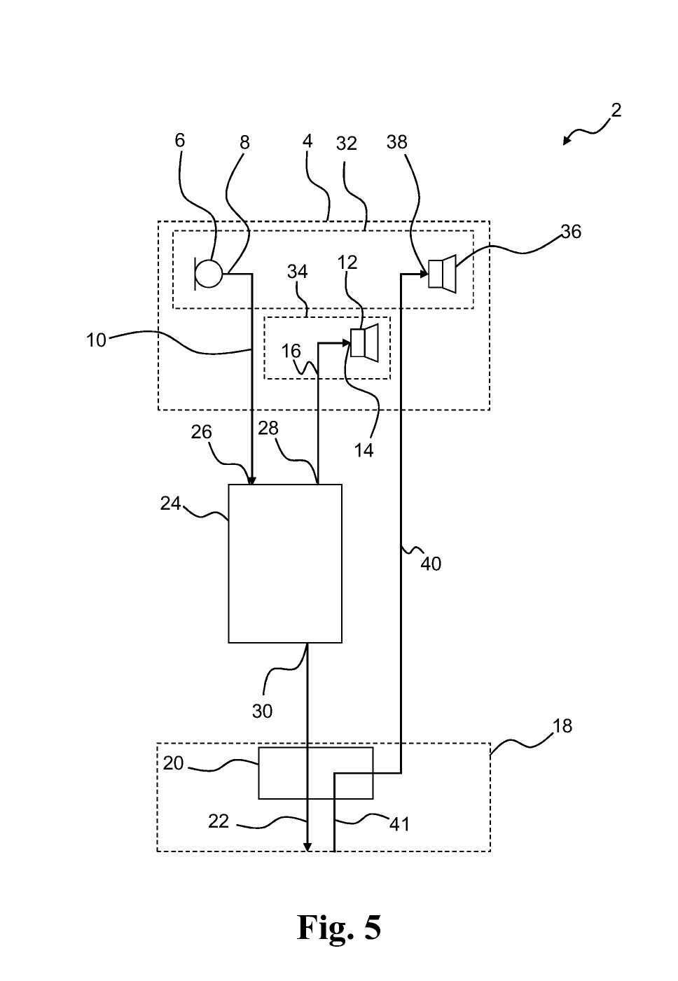

FIG. 5 schematically illustrates an exemplary microphone system 2, wherein the head part 4 comprises a first part 32 and a second part 34. The first part 32 comprises the microphone 6 and the second loudspeaker 36. The second part 34 comprises the first loudspeaker 12. Further, the second loudspeaker 36 receives a second loudspeaker signal 40 from the connector 18. The connector 18 comprises a second terminal 41 connected to the second loudspeaker input.

The second loudspeaker signal 40 may, as illustrated in FIG. 5, be provided by the auxiliary device connected to the connector 18 via the second terminal 41, and may be e.g. audible cues from a manager, or information from other musicians. In an alternative microphone system, the second terminal 41 may be comprised in a second connector (not shown) such that the first terminal 22 is able to be connected to a first auxiliary device, and the second terminal 41 is able to be connected to a second auxiliary device.

Benefits of the configuration as illustrated in FIG. 5, where the microphone 6 is provided in the first part 32 and the first loudspeaker 12 is provided in the second part 34, is discussed in relation to FIG. 3. Thus in configuration as illustrated in FIG. 5, where the first loudspeaker signal 16 and the second loudspeaker signal 40 are not identical, it may assist in reducing feedback, i.e. echo effects to provide the second loudspeaker 36 and the microphone 6 in the same part of the head part 4, i.e. the first part 32.

However, in other embodiments the microphone 6 and the first loudspeaker 12 connected to the first output 28 may be comprised in the same head part, e.g. the first head part 32. Comprising the microphone 6 and the first loudspeaker 12 in the same head part may be beneficial in order to obtain a compact device, where the microphone 6, the first loudspeaker 12 and the preprocessing unit 24 are comprised in the same single part, such as the first head part 32.

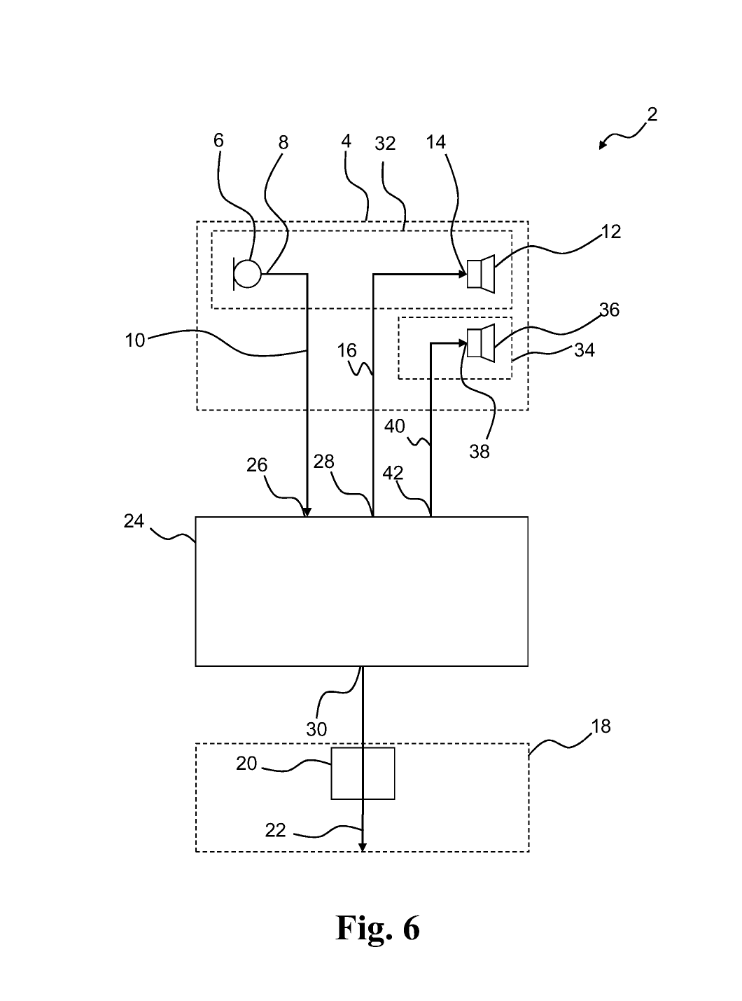

FIG. 6 schematically illustrates an exemplary microphone system 2, wherein the preprocessing unit 24 comprises a third output 42. The third output 42 is connected to the second loudspeaker input 38, and thus provides the second loudspeaker signal 40 to the second loudspeaker 36.

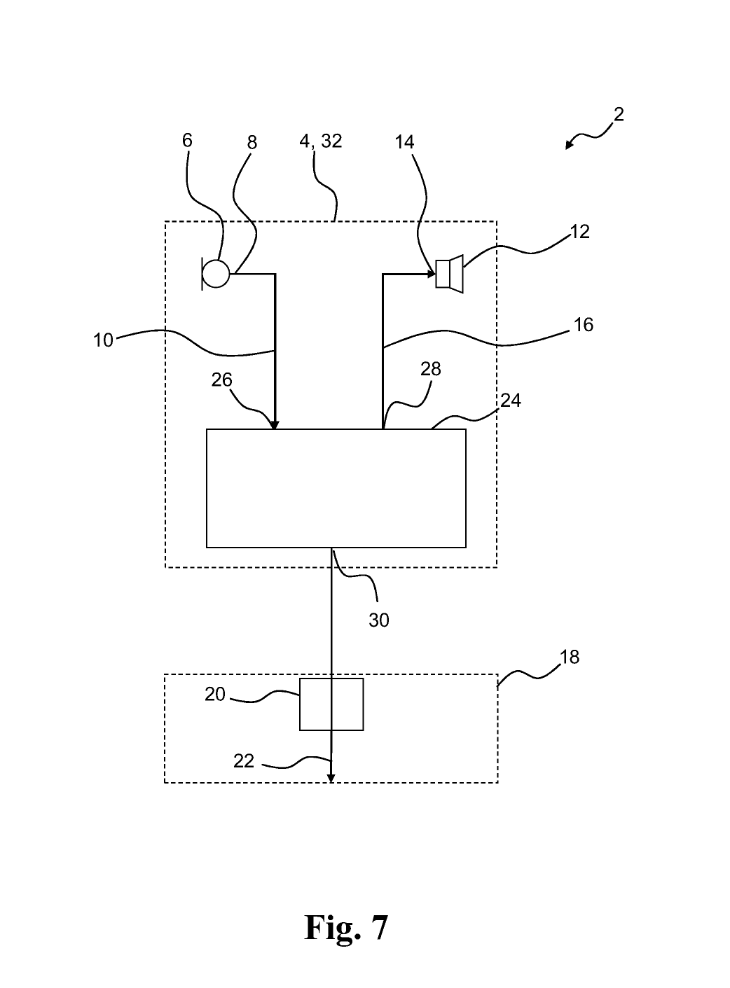

FIG. 7 schematically illustrates an exemplary microphone system 2 wherein the head part 4 comprises the preprocessing unit 24. In relation to FIG. 1, the preprocessing unit 24 may e.g. be comprised in the base part 15 of the first ear hook 13. The preprocessing unit is in FIG. 7 shown as being provided in the first part 32 of the head part 4, it may also be provided in a second part 34 of the head part 4.

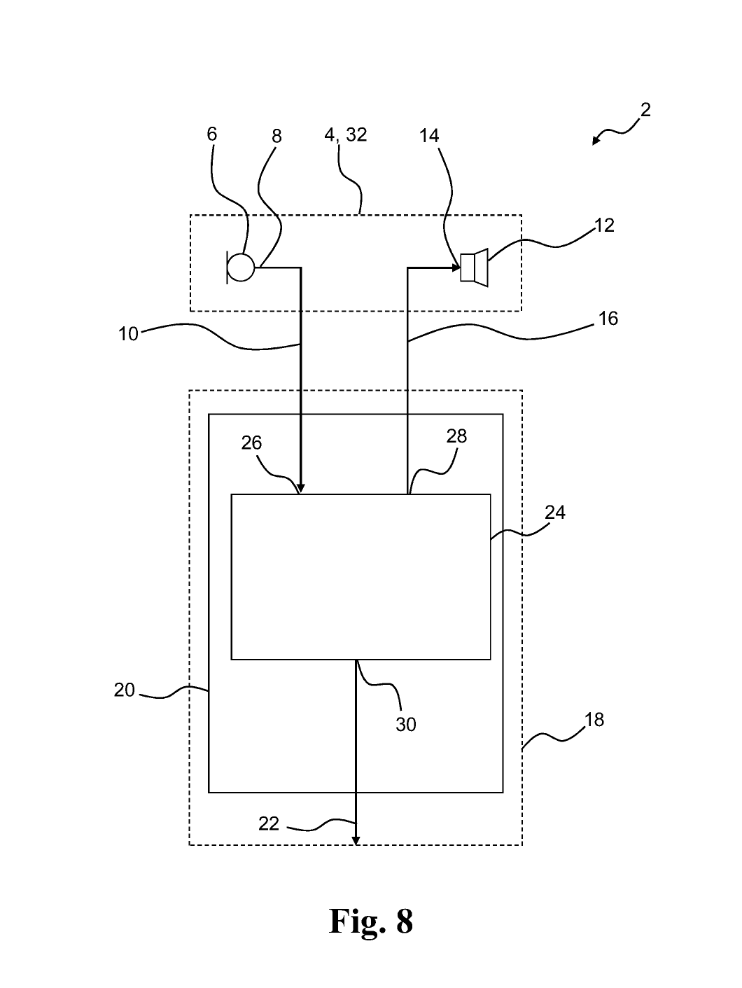

FIG. 8 schematically illustrates an exemplary microphone system 4 wherein the connector housing 20 comprises the preprocessing unit 24.

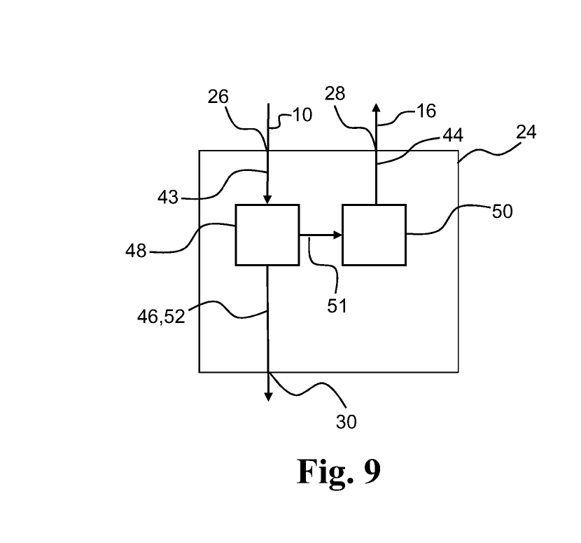

FIG. 9 schematically illustrates an exemplary preprocessing unit 24 for providing monitor sound. The preprocessing unit 24 of FIG. 9 comprises a first input 26, a first output 28 and a second output 30. Further the preprocessing unit 24 comprises a splitter circuit 48 and an amplifier circuit 50.

The preprocessing unit 24 is adapted to receive a microphone signal 10 on the first input 26 to form a first input signal 43. The first input signal 43 is processed by the preprocessing unit 24, to form a first output signal 44 on the first output 28, and a second output signal 46 on the second output 30.

The preprocessing unit 24 processes the first input signal 43 by splitting the first input signal 43 in the splitter circuit 48, forming a first split signal 51 and a second split signal 52 of the first input signal 43. The first split signal 51 is amplified by the amplifier 50 to form the first output signal 44 on the first output 28. The second split signal 52 is forming the second output signal 46 on the second output 30.

The preprocessing unit 24 may comprise an internal power source, such as a battery, or the preprocessing unit 24 may be powered via an external power source, such as an auxiliary device.

Referring to FIG. 2-8 in combination with FIG. 9, the first output signal 44 is forming the first loudspeaker signal 16.

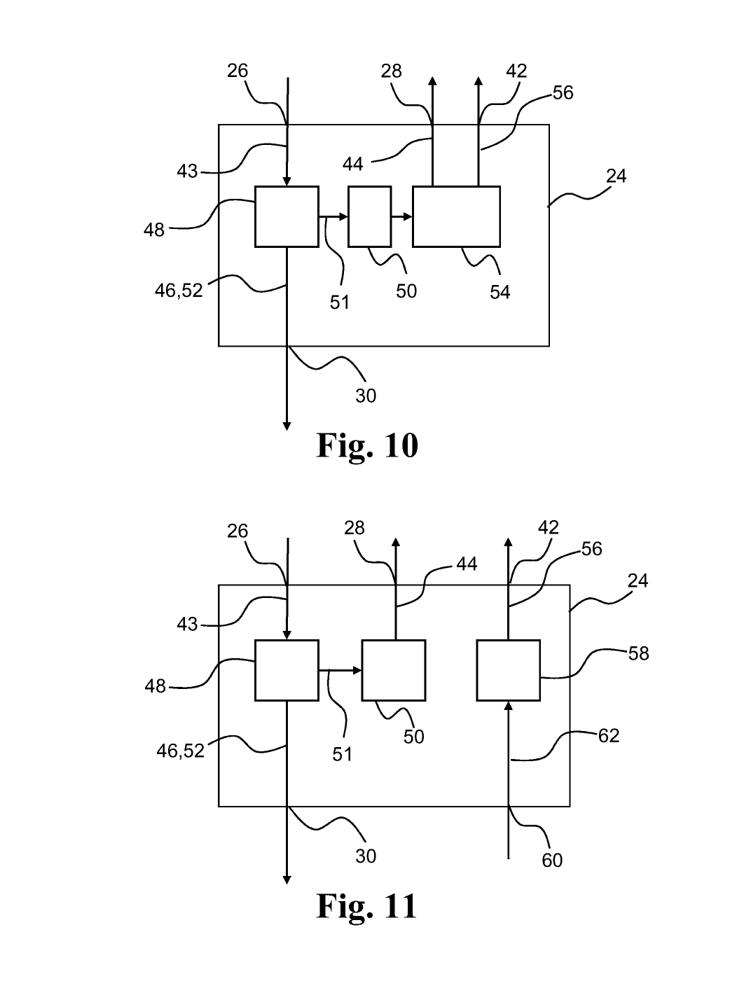

FIG. 10 schematically illustrates an exemplary preprocessing unit 24 comprising a third output 42 and a second splitter circuit 54. The preprocessing unit 24 as illustrated in FIG. 10, comprising a third output 42 may be used in relation to a microphone system comprising a head part comprising two loudspeakers, such as a microphone system 2 as illustrated e.g. in FIG. 6. The preprocessing unit 24, as illustrated in FIG. 10, comprises a second splitter circuit 54 which splits the output of the amplifier to form the first output signal 44 on the first output 28 and a third output signal 56 on the third output 42.

FIG. 11 schematically illustrates an exemplary preprocessing unit 24 comprising a second amplifier circuit 58 and a second input 60. The second input receives a second input signal 62, e.g. from an auxiliary device. The second amplifier circuit 58 is adapted to amplify the second input signal 62 and forming the third output signal 56 on the third output 42. A gain of the first amplifier circuit 50 and the second amplifier circuit 58 may be the same, or may be adjusted independently and/or collectively.

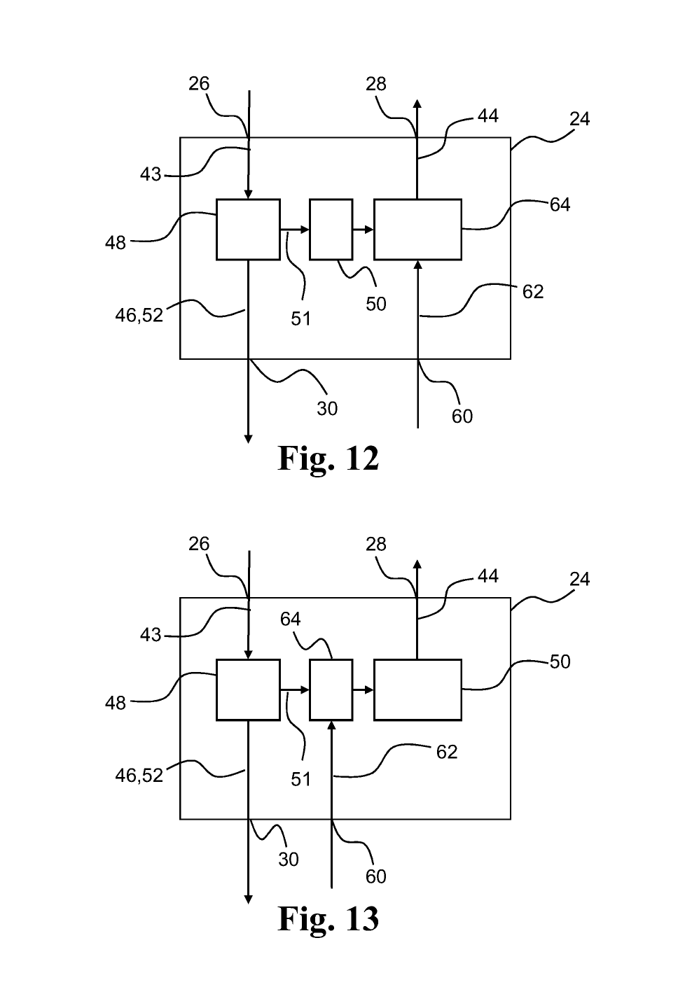

FIG. 12 schematically illustrates an exemplary preprocessing unit 24 comprising a combiner circuit 64. The combiner circuit 64 combines the second input signal 62 with a signal from the first amplifier circuit 50 to form the first output signal 44 on the first output 28. In this exemplary preprocessing unit 24 the first output signal 44 is based both on a second input signal 62, such as an external signal, received on the second input 60, and on a first input signal 43, such as a microphone signal 10 received on the first input 26. A signal based on both inputs is thus provided through a single loudspeaker. The external signal may be such as cues from a producer or other band members.

FIG. 13 schematically illustrates an exemplary preprocessing unit 24 with similar features as the preprocessing unit illustrated in FIG. 12. In the preprocessing unit 24 of FIG. 13, the combiner circuit 64 is positioned before the first amplifier circuit 50, such that the second input signal 62 is combined with the first split signal 51, and the combined output signal is amplified by the first amplifier circuit to form the first output 44 on the first output 28.

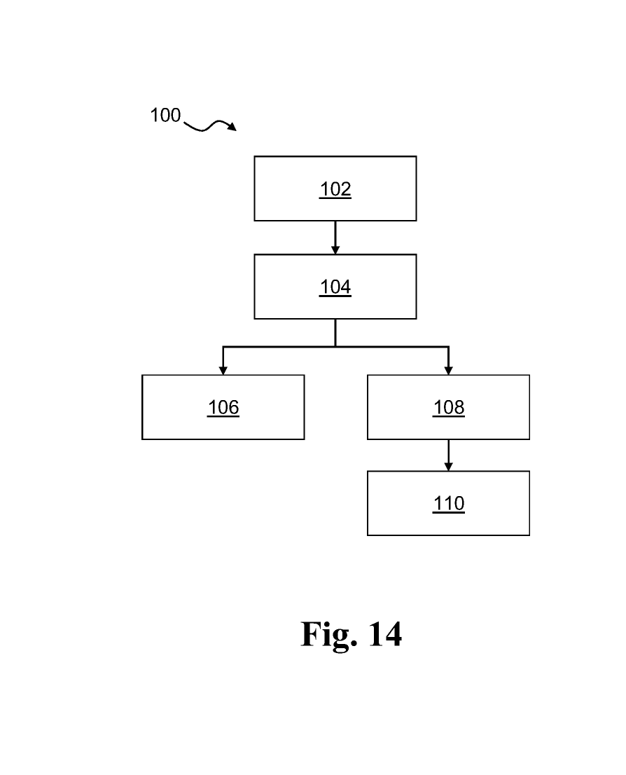

FIG. 14 schematically illustrates a flow diagram of an exemplary method 100 for providing monitor sound. The method 100 is configured to provide monitor sound in a microphone system comprising a microphone and a first loudspeaker. The method 100 provides monitor sound in the first loudspeaker with reduced or no delay. The method 100 comprises receiving a microphone signal 102. The received microphone signal 102 is processed 104 to form a first output signal and a second output signal. The processing of the microphone signal 104 comprises amplification of at least a part of the received microphone signal 102 to form the first output signal.

The first output signal is applied to a first output 106. The second output signal may be applied to a second output. In the illustrated method 100, the second output is digitalized 108 and subsequently applied to the second output 110. In other embodiments, the digitalization of the second output is omitted, and the second output is applied to the second output 110 in an analog form.

Apparatuses, systems, and methods are disclosed in the following items:

Item 1. Microphone system comprising a microphone with a microphone output for converting a first acoustic audio signal to a microphone signal, the microphone system comprising:
a head part comprising a first loudspeaker with a first loudspeaker input for converting a first loudspeaker signal to a second acoustic audio signal;
a first connector for connecting the microphone system to an auxiliary device, the first connector comprising a connector housing and a first terminal;
a preprocessing unit for preprocessing the microphone signal, the preprocessing unit having at least a first input connected to the microphone output, a first output connected to the first loudspeaker input, and a second output connected to the first terminal of the first connector;

wherein the preprocessing unit is configured to:
receive the microphone signal on the first input to form a first input signal; and
process the first input signal to form a first and second output signal on the first and second output, respectively, wherein the first output signal and the second output signal are based on the first input signal.

Item 2. Microphone system according to item 1, wherein the head part comprises the microphone.

Item 3. Microphone system according to item 2, wherein the head part comprises a first part with the microphone, and a second part with the first loudspeaker.

Item 4. Microphone system according to any of the preceding items, the microphone system comprising a first output member configured for directing the second acoustic audio signal into a first ear of a user.

Item 5. Microphone system according to any of the preceding items, the microphone system comprising a second loudspeaker with a second loudspeaker input for converting a second loudspeaker signal to a third acoustic audio signal.

Item 6. Microphone system according to item 5, the microphone system comprising a second output member configured for directing the third acoustic audio signal into a second ear of a user.

Item 7. Microphone system according to any of items 5-6, wherein the first output of the preprocessing unit is connected to the first loudspeaker input and the second loudspeaker input.

Item 8. Microphone system according to any of items 5-6, wherein the preprocessing unit comprises a third output connected to the second loudspeaker input.

Item 9. Microphone system according to any of the preceding items, wherein one or more processing parameters in the preprocessing unit are adjustable.

Item 10. Microphone system according to any of the preceding items, wherein the preprocessing unit comprises a splitter circuit for splitting the first input signal.

Item 11. Microphone system according to any of the preceding items, wherein the preprocessing unit comprises a first amplifier between the first input and the first output.

Item 12. Microphone system according to any of the preceding items, wherein the preprocessing unit comprises an analog to digital converter between the first input and the second output, and wherein processing the microphone signal comprises analog to digital conversion of at least a part of the first input signal to form the second output signal.

Item 13. Microphone system according to any of the preceding items, wherein the preprocessing unit comprises a second input for receiving a second input signal, and wherein the first and/or third output signal is based on the second input signal.

Item 14. Microphone system according to item 13, wherein the first connector comprises a second terminal connected to the second input of the preprocessing unit.

Item 15. Microphone system according to item 13, wherein the microphone system comprises a second connector, the second connector comprising a second connector housing and the second terminal connected to the second input of the preprocessing unit.

Item 16. Microphone system according to any of the preceding items, wherein the preprocessing unit is comprised in the first connector housing.

Item 17. Microphone system according to any of items 1-15, wherein the preprocessing unit is comprised in the head part.

Item 18. A method for providing monitor sound in a microphone system comprising a microphone and a first loudspeaker, the method comprising:
receiving a microphone signal from the microphone to form a first input signal;
forming a first output signal and a second output signal, wherein the first output signal and the second output signal are based on the first input signal;
applying the first output signal to a first output, wherein the first output is configured to be connected to the first loudspeaker; and
applying the second output signal to a second output.

Item 19. Method according to item 18, wherein the method comprises forming a third output signal, and applying the third output signal to a third output, wherein the third output is configured to be connected to a second loudspeaker.

Item 20. Method according to item 19, wherein the third output signal is based on the first input signal.

Item 21. Method according to any of items 18-20, wherein the method comprises receiving an external input signal to form a second input signal, and wherein the first and/or third output signals are based on the second input signal.

Item 22. Preprocessing unit for preprocessing a microphone signal from a microphone system with a microphone and a first loudspeaker, the preprocessing unit having at least a first input for receiving a microphone signal, a first output for connecting to a first loudspeaker input, and a second output; wherein the preprocessing unit is configured to:
receive a microphone signal to form a first input signal;
form a first output signal and a second output signal, wherein the first output signal and the second output signal are based on the first input signal;
apply the first output signal to the first output; and
apply the second output signal to the second output.

Item 23. Preprocessing unit according to item 22, wherein the preprocessing unit comprises a third output for connecting to a second loudspeaker input, and the preprocessing unit is configured to form a third output signal and apply the third output signal to the third output.

Item 24. Preprocessing unit according to item 23, wherein the third output signal is based on the first input signal.

Item 25. Preprocessing unit according to any of items 22-24, wherein the preprocessing unit comprises a second input for receiving a second input signal, and wherein the first and/or third output signal are based on the second input signal.

Item 26. Connector device for a microphone system with a microphone and a first loudspeaker, the connector device comprising a housing accommodating a preprocessing unit according to any of items 22-25.

### LIST OF REFERENCES

2 microphone system
4 head part
6 microphone
7 microphone boom
8 microphone output
10 microphone signal
12 first loudspeaker
13 first earhook
14 first loudspeaker input
15 base part of first earhook
16 first loudspeaker signal
17 conductor
18 connector
20 connector housing
22 first terminal
24 preprocessing unit
26 first input
28 first output
30 second output
32 first part
34 second part
36 second loudspeaker
38 second loudspeaker input
40 second loudspeaker signal
41 second terminal
42 third output
43 first input signal
44 first output signal
46 second output signal
48 first splitter circuit
50 first amplifier circuit
51 first split signal
54 second splitter circuit
56 third output signal
58 second amplifier circuit
60 second input
62 second input signal
64 combiner circuit
100 method for providing monitor sound
102 receiving a microphone signal
104 processing the microphone signal (to form a first and second output signal)
106 apply first output signal to the first output
108 digitalize the second output signal
110 apply second output signal to the second output

1. Microphone system comprising a microphone with a microphone output for converting a first acoustic audio signal to a microphone signal, the microphone system comprising:
a head part comprising a first loudspeaker with a first loudspeaker input for converting a first loudspeaker signal to a second acoustic audio signal;
a first connector for connecting the microphone system to an auxiliary device, the first connector comprising a connector housing and a first terminal;
a preprocessing unit for preprocessing the microphone signal, the preprocessing unit having at least a first input connected to the microphone output, a first output connected to the first loudspeaker input, and a second output connected to the first terminal of the first connector;
wherein the preprocessing unit is configured to:
receive the microphone signal on the first input to form a first input signal; and
process the first input signal to form a first and second output signal on the first and second output, respectively, wherein the first output signal and the second output signal are based on the first input signal.

2. Microphone system according to claim 1, wherein the head part comprises the microphone.

3. Microphone system according to claim 2, wherein the head part comprises a first part with the microphone, and a second part with the first loudspeaker.

4. Microphone system according to claim 1, the microphone system comprising a first output member configured for directing the second acoustic audio signal into a first ear of a user.

5. Microphone system according to claim 1, the microphone system comprising a second loudspeaker with a second loudspeaker input for converting a second loudspeaker signal to a third acoustic audio signal.

6. Microphone system according to claim 1, wherein one or more processing parameters in the preprocessing unit are adjustable.

7. Microphone system according to claim 1, wherein the preprocessing unit comprises an analog to digital converter between the first input and the second output, and wherein processing the microphone signal comprises analog to digital conversion of at least a part of the first input signal to form the second output signal.

8. Microphone system according to claim 1, wherein the preprocessing unit comprises a second input for receiving a second input signal, and wherein the first and/or third output signal is based on the second input signal.

9. Microphone system according to claim 1, wherein the preprocessing unit is comprised in the head part.

10. Microphone system according to claim 1, wherein the preprocessing unit is comprised in the connector housing.

11. A method for providing monitor sound in a microphone system comprising a microphone and a first loudspeaker, the method comprising:
receiving a microphone signal from the microphone to form a first input signal;
forming a first output signal and a second output signal, wherein the first output signal and the second output signal are based on the first input signal;
applying the first output signal to a first output, wherein the first output is configured to be connected to the first loudspeaker; and
applying the second output signal to a second output.

12. Method according to claim 11, wherein the method comprises forming a third output signal, and applying the third output signal to a third output, wherein the third output is configured to be connected to a second loudspeaker.

13. Method according to claim 11, wherein the method comprises receiving an external input signal to form a second input signal, and wherein the first and/or third output signals are based on the second input signal.

14. Preprocessing unit for preprocessing a microphone signal from a microphone system with a microphone and a first loudspeaker, the preprocessing unit having at least a first input for receiving a microphone signal, a first output for connecting to a first loudspeaker input, and a second output; wherein the preprocessing unit is configured to:
receive a microphone signal to form a first input signal;
form a first output signal and a second output signal, wherein the first output signal and the second output signal are based on the first input signal;
apply the first output signal to the first output; and
apply the second output signal to the second output.

15. Preprocessing unit according to claim 14, wherein the preprocessing unit comprises a third output for connecting to a second loudspeaker input, and the preprocessing unit is configured to form a third output signal and apply the third output signal to the third output.

16. Preprocessing unit according to claim 14, wherein the preprocessing unit comprises a second input for receiving a second input signal, and wherein the first and/or third output signal are based on the second input signal.

17. Connector device for a microphone system with a microphone and a first loudspeaker, the connector device comprising a housing accommodating a preprocessing unit according to claim 14.
